(19) United States
(12) Patent Application Publication
(10) Pub. No.: US 2006/0117641 A1
(43) Pub. Date: Jun. 8, 2006

(54) Lure for sportsfishing comprising two members enclosing a variable cavity

(76) Inventor: Krister Kumlin, Svanskog (SE)

Correspondence Address: NIXON & VANDERHYE, PC, 901 NORTH GLEBE ROAD, 11TH FLOOR, ARLINGTON, VA, 22203, US

(21) Appl. No.: 10/559,788

(22) PCT Filed: May 21, 2004
(86) PCT No.: PCT/SE04/00780

§ 371 Date: Dec. 8, 2005

(30) Foreign Application Priority Data
Jun. 12, 2003 (SE) 0301737-3
Oct. 9, 2003 (SE) 0302672-1

(51) Int. Cl. A01K 85/00

(52) U.S. Cl. 43/42.22; 43/42.35; 43/43.14

(57) ABSTRACT

A lure for use when angling with a fishing rod and line. The lure has a first structural member and a second structural member, said structural members enclosing at least one cavity, having a volume which is variable by means of a relative movement between the structural members, said relative movement bringing about a change of displacement of the lure.

The invention relates to a lure comprising at least one point of attachment for a line and at least one point of attachment for a hook.

More particularly, the invention relates to a lure for use when angling with a fishing rod and line. Accordingly, in this context “lure” refers to an artificial, hook-equipped bait which attracts fish to bite when it is pulled through the water. In particular, the invention relates to the type of fish-like lures which performs wobbling movements in the water when used, said type also being known under the designation “wobbler”.

In order to enable an angler to practice an efficient fishing, it is of great importance that he is capable of varying the fishing depth, i.e. the depth at which his lure is fishing, and the speed of retrieval, i.e. the speed at which he gets the lure to travel through the water. For a conventional lure, a given fishing depth normally is associated with a certain speed of retrieval, i.e. the angler regulates the fishing depth by means of changing the speed of retrieval. This is a disadvantage, since the angler normally wants to fish with a speed of retrieval which is optimal for the fishing situation in question at all fishing depths.

As a rule, the angler is obliged to switch between similar lures having different buoyancies in order to change the fishing depth while maintaining the optimal speed of retrieval. The buoyancy or floating capability of a lure in general, and especially a wobbler, is decided by the ratio between the mass of the lure and the mass of the water quantity being displaced when the lure is immersed completely or partially in water, i.e. the displacement of the lure. A conventional lure has a constant displacement and a constant weight and, consequently, also a constant buoyancy. The buoyancy of wobblers can be positive, neutral or negative, i.e. a conventional wobbler can have a specific gravity which either is smaller than, approximately equal to, or larger than the specific gravity of water. The type of wobbler an angler selects for a given fishing opportunity depends on the fishing situation in question, i.e. if he wants to fish deep or shallow; with fast or slow speed of retrieval. Consequently, an angler has to have access to a number of different wobblers at the fishing-grounds in order to handle different fishing situations; sinking, floating and neutral, said number of wobblers being difficult to carry about, on one hand, and representing a relatively large cost price, on the other hand.

It is true that-there are lures where the fishing depth can be regulated without changing the speed of retrieval. In one type of such lures, the regulation is done by means of changing the attachment of the fishing line to the lure between a number of predetermined points of attachments, usually two. There is also a type of wobbler where the spoon of the wobbler can be adjusted between a number of positions, usually three, said positions providing different fishing depths at the same speed of retrieval. The disadvantage with these types of lures, however, is that the number of possible settings is limited, and that the fishing depth setting is discreet.

The object of the present invention is to achieve a lure by means of which an unlimited number of settings of the fishing depth is possible, independently of the speed of retrieval.

The invention is characterized in that the lure comprises at least one first structural member and at least one second structural member, said structural members enclosing at least one cavity having a volume which is variable by means of a relative movement between the structural members, said relative movement bringing about a change of displacement of the lure.

Accordingly, by means of a lure according to the invention, it is possible to vary the displacement of the lure, and thereby also the floating capability or buoyancy of the lure, at a substantially unchanged weight of the lure.

In the following, the invention will be described in greater detail with reference to the figures.

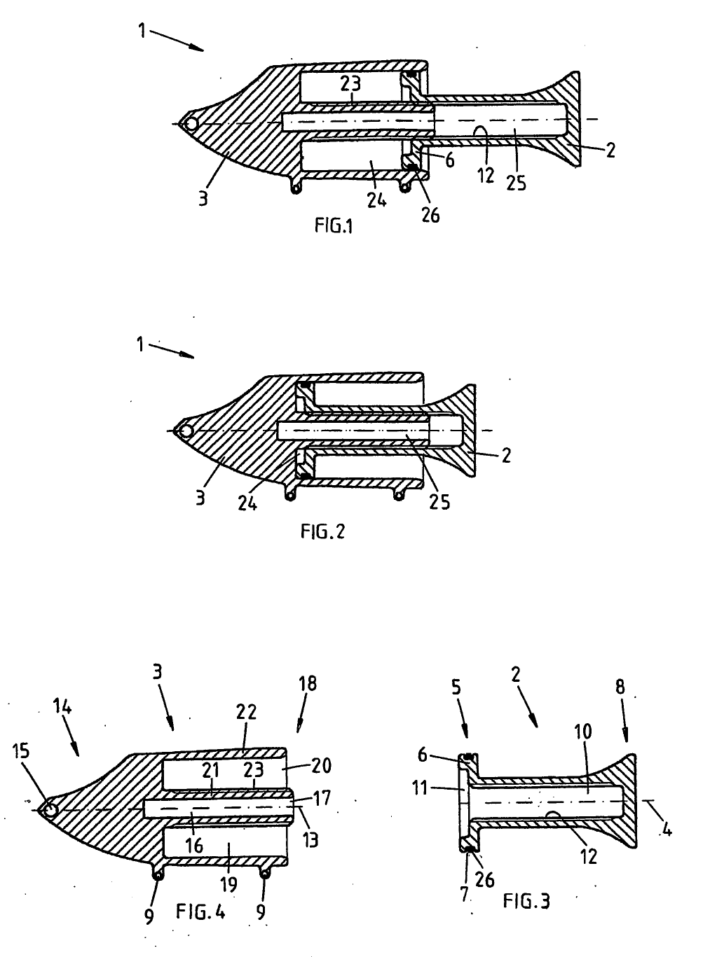

FIG. 1 and 2 show sectional views of a wobbler according to the invention.

FIG. 3 shows a sectional view of a first structural member, being part of the wobbler according to FIG. 1 and 2.

FIG. 4 shows a sectional view of a second structural member, being part of the wobbler according to FIG. 1 and 2.

FIG. 5 shows a wobbler according to the invention being fitted with hooks.

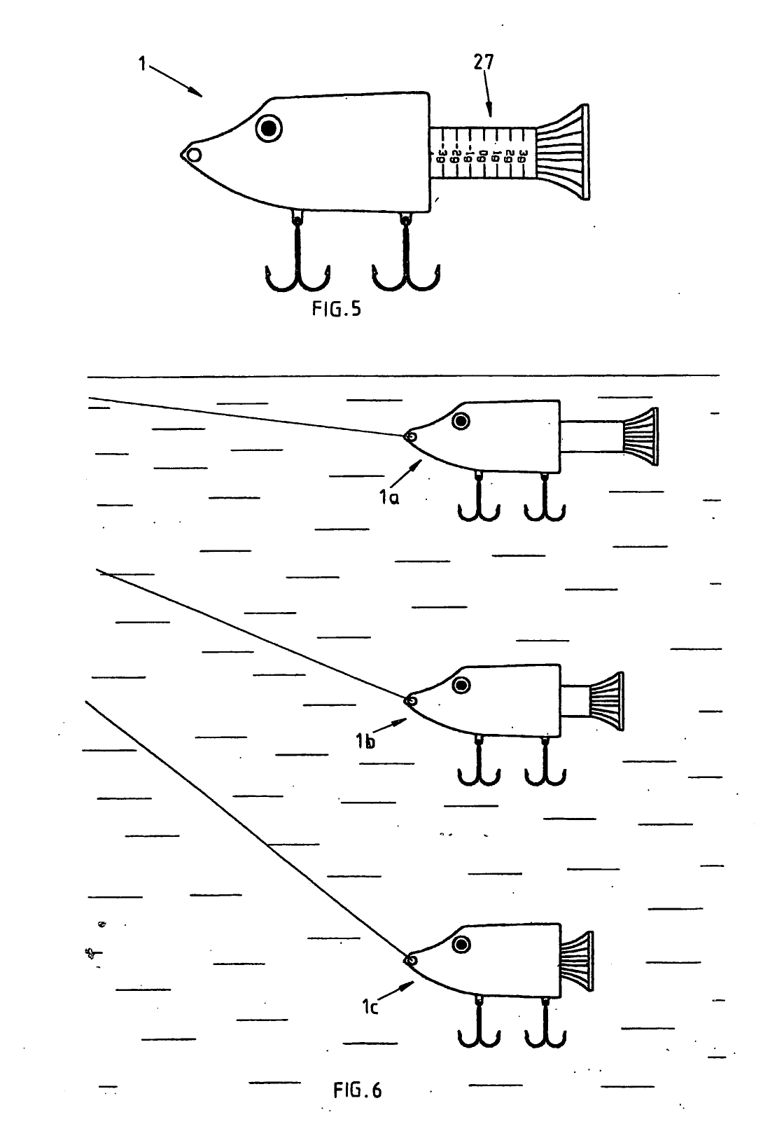

FIG. 6 shows three identical wobblers according to the invention in three different buoyancy positions.

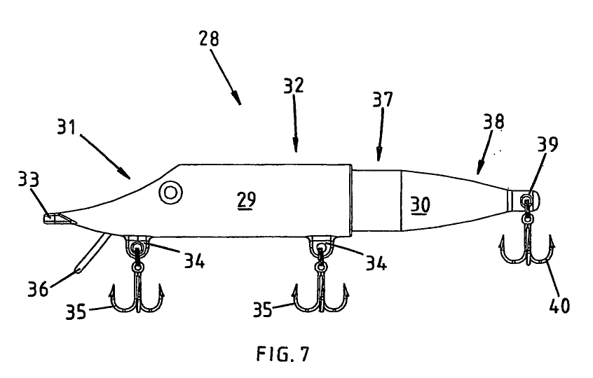

FIG. 7 shows a second embodiment of a wobbler according to the invention.

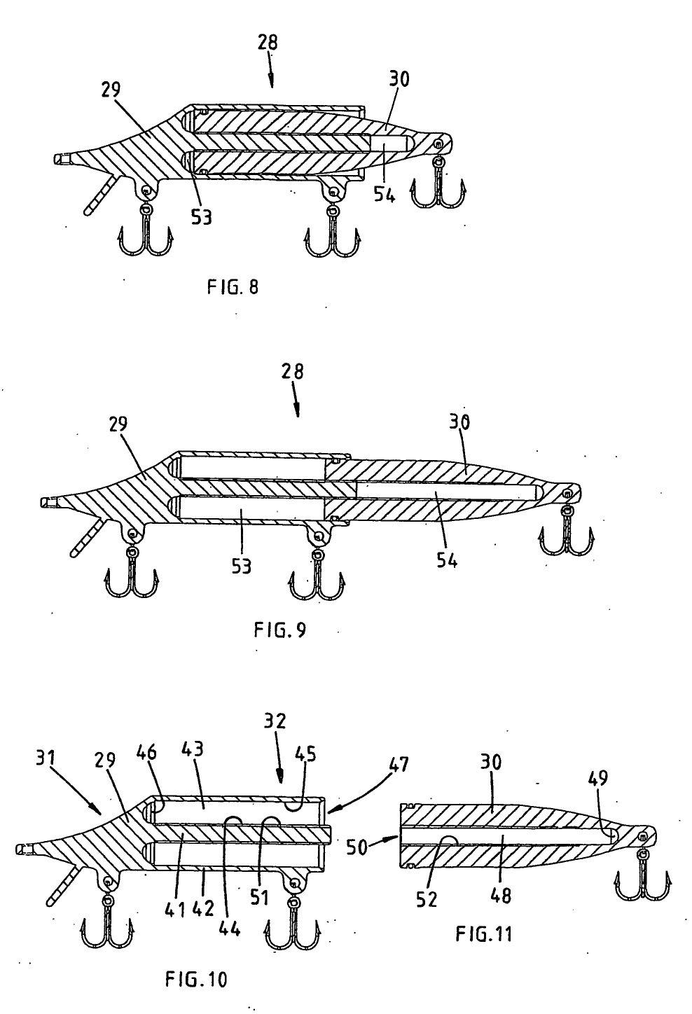

FIG. 8 shows a sectional view of the wobbler according to FIG. 7 when in a first extreme position.

FIG. 9 shows a sectional view of the wobbler according to FIG. 7 when in a second extreme position.

FIG. 10 shows a sectional view of a first structural member, being part of the wobbler according to FIG. 7.

FIG. 11 shows a sectional view of a second structural member, being part of the wobbler according to FIG. 7.

FIG. 1 and 2 show a lure in the form of wobbler 1, comprising a first structural member 2, shown in greater detail in FIG. 3, and a second structural member 3, shown in greater detail in FIG. 4.

The first structural member 2 has an elongated shape and is, on the whole, rotationally symmetrical around a symmetry axis 4. At a first one 5 of its ends, the first structural member 2 exhibits a flange 6 projecting radially in relation to the symmetry axis 4. The flange 6, in its turn, exhibits an external groove 7 running circumferentially around the flange 6. At its second end 8, the first structural member 2 exhibits a portion having an increased radial extension length. The first structural member 2 further exhibits a recess l0, which is substantially circularly cylindrical and centered around the symmetry axis 4, and which extends through the main portion of the first structural member 2 and ends in an opening 11 at the first end 5. The first structural member 2 exhibits an internal thread groove 12 at the internal cylinder surface delimiting the recess 10.

Also the second structural member 3 has an elongated shape and is substantially rotationally symmetrical around a symmetry axis 13, with the exception of a first one 14 of the ends of the second structural member 3, where the second structural member 3 has a fishhead-like shape and exhibits a through-eye 15 for the reception of a fishing line (see FIG. 6). The second structural member 3 also exhibits a first recess 16, which has a substantially circularly cylindrical shape and is centered around the symmetry axis 13, and which ends in a first opening 17 at the second end 18 of the second structural member 3. The second structural member 3 also exhibits a second recess 19, which is concentric with the first recess 16 and ends in a second opening 20 at the second end 18. Accordingly, in a radial direction, the first and second recesses 16, 19 are delimited by a first, internal 21, and a second, external 22 tubular portion of the second structural member 3, said portions 21, 22 being arranged concentrically around the symmetry axis 13. The internal portion 21 exhibits an external thread groove 23, having the same dimensions as the internal thread groove 12 of the first structural member 2. At its belly portion, the second structural member 3 exhibits two through-eyes 9 for the attachment of hooks (see FIG. 5).

In order to form the finished wobbler 1, the first structural member 2 is inserted into the second opening 20 of the second structural member 3, so that a threaded engagement is created between the thread grooves 12 and 23, something which is illustrated in FIG. 1 and 2. Thereby, the recess 19 and the flange 6 define a first air-filled cavity 24 and the recesses 10 and 16 a second air-filled cavity 25 of the wobbler 1. The wobbler 1 comprises a sealing 26, which is arranged in the groove 7 of the flange 6 in order to prevent water from penetrating into the cavities 24 and 25 when the wobbler 1 is used. It will be understood that, owing to the design of the wobbler 1, the thread grooves 12 and 23 always are protected from external influence.

By means of a rotary motion of the first structural member 2 in relation to the second structural member 3, the wobbler is adjustable between a first position, shown in FIG. 1, and a second position, shown in FIG. 2. In the first position, the cavities 24, 25 have relatively large volumes and the wobbler 1 has a relatively large displacement. In the second position, the cavities 24, 25 have relatively small volumes and the wobbler 1 has a relatively small displacement. Since the weight of the wobbler 1 is substantially constant, the wobbler 1 has a larger buoyancy in the first position than in the second position.

By means of different selections of materials and dimensions, different buoyancy intervals can be obtained for a wobbler according to the invention. For example, the wobbler can be designed so that it is floating in its first position and is sinking in its second position. FIG. 5 shows such a wobbler 1, having a readable scale 27 which indicates the buoyancy of the wobbler 1. FIG. 6 shows three identical wobblers according to the invention. The wobbler la at the top is set so that it floats, the wobbler 1b in the middle so that it “is suspended” in the water, and the wobbler at the bottom 1c so that it sinks. It will be understood, however, that the buoyancy intervals can be selected so that they are entirely within the floating or the sinking range.

FIG. 7-9 show a further embodiment of a wobbler 28 according to the invention. The wobbler 28 comprises an elongated first, front-end structural member 29 and an elongated second, rear-end structural member 30, said structural members 29 and 30 forming a wobbler body. The front-end structural member 29 comprises a fishhead-shaped front portion 31 and a substantially circularly cylindrical rear portion 32. At its front end, the front portion 31 exhibits an attachment member 33 for a line, and at its underside the front-end structural member 29 exhibits two attachment members 34 for triple hooks 35. The front portion 31 further exhibits a so-called “spoon” 36, i.e. a protruding and substantially flat or slightly cupped portion, which in a fashion which is known per se is arranged at the chin portion of the front portion 31 in order to generate the oscillating motion of the wobbler 28 when the wobbler 28 is brought to travel through the water. The rear-end structural member 30 comprises a substantially circularly cylindrical front portion 37, and a substantially cone-shaped rear portion 38. At its rear end the rear portion 38 exhibits an attachment member 39 for a triple hook 40.

In the following, the structural members 29 and 30 will be described in greater detail with reference to FIG. 10 and 11, which show sectional views of the front-end and rear-end structural members 29 and 30, respectively.

The circularly cylindrical rear portion 32 of the front-end structural member 29 comprises a circularly cylindrical axle portion 41, which has a circular cross-section and is arranged axially in the rear portion 32. The rear portion 32 also comprises a tubular tube portion 42, which is arranged concentrically with the axle portion 41. At their front end, both the axle portion 41 and the tube portion 42 are connected to the fishhead-like front portion 31 of the front-end structural member 29. The rear portion 32 also comprises a recess 43 between the axle portion 41 and the tube portion 42. In a radial direction, the recess 43 is delimited by an external shell surface 44 of the axle portion 41 and an internal surface 45 of the tube portion 42. The recess 43 extends substantially through the entire length of the rear portion 32 and is delimited, in a forward direction, by an annular bottom surface 46. In a rearward direction, the recess 43 is open and ends in an annular opening 47.

The rear-end structural member 30 is substantially rotationally symmetrical and comprises a recess 48, which has a circular cross-section and is arranged axially in the rear-end structural member 30. In a rearward direction, the recess 48 is delimited by a bottom surface 49. In a forward direction, the recess 48 is open and ends in a circular opening 50.

The external shell surface 44 of the axle portion 41 exhibits an external thread groove 51. The cylinder surface delimiting the recess 48 exhibits a corresponding, internal thread groove 52, which is arranged for interacting with the thread groove 51 of the axle portion 41. In order to form the finished wobbler body, the axle portion 41 of the first structural member 29 is inserted into the opening 50 of the second structural member 20, so that a threaded engagement is created between the thread grooves 51 and 52. This is illustrated in FIG. 8 and 9, which show sectional views of the wobbler 28. Thereby, a portion of the recess 43 of the front-end structural member 29 defines a first, variable cavity 53 of the wobbler 28, and a portion of the recess 48 of the rear-end structural member 30 defines a second, variable cavity 54 of the wobbler 28.

The rear-end structural member 30 further comprises a sealing member 55, which is arranged in order to prevent water from penetrating into the cavity 53 when the wobbler 28 is used. The sealing member 55 comprises an external groove 56 which, in a circumferential direction, runs around the rear-end structural member 30 at its front end, and a sealing ring 57 arranged in the groove 56. Thereby, the sealing-ring 57 is arranged for contacting the front-end structural member 29 in order to make the cavity 53 watertight.

By means of a rotary motion of the rear-end structural member 30 in relation to the front-end structural member 29, the wobbler 28 is adjustable between a first extreme position, shown in FIG. 8, and a second extreme position, shown in FIG. 9. In the first extreme position, the cavities 53, 54 have relatively small volumes and, consequently, the wobbler 28 has a relatively small displacement, i.e. the weight of the water quantity being displaced when the wobbler is immersed-in water is relatively small. In the second extreme position, the cavities 53, 54 have relatively large volumes, and the wobbler 28 has a relatively large displacement.

In order prevent the rear-end structural member 30 from coming loose unintentionally from the front-end structural member 29, for example when a fish bites, the wobbler 28 preferably comprises a device (not shown) which ensures that a predetermined minimum threaded engagement is not fallen short of when fishing. Such a device could be an annular marking on the surface of the rear-end structural member 30, said marking becoming visible and alerting the angler when the rear-end structural member 30 is unscrewed to such an extent that the predetermined minimum threaded engagement is fallen short of.

Preferably, the structural members 29,30 are made of moulded acetal plastic, having a density of the magnitude 1.4 grams per cubic centimetre.

Trials have shown that the volume increase of the wobbler, when it is brought from the first to the second extreme position, should be at least 10%, preferably at least 15% or more, in order to obtain a change of buoyancy which is effective in practical fishing. In the embodiment shown in FIG. 7-9, the cavities 53 and 54 have a total first volume v₁, which is about 4.3 cubic centimetres in the first extreme position, and in this position the wobbler 28 has a total volume V₁ which is about 32.3 cubic centimetres. Accordingly, in the first extreme position, the cavity share of the total volume is about 13%. In the second extreme position, the cavities 53 and 54 have a total second volume v₂ which is about 17.7 cubic centimetres and, accordingly, the wobbler 28 has a total volume V₂ which is V₁+(v₂−v₁) in the second extreme position, i.e. 45.7 cubic centimetres. Accordingly, in the second extreme position, the cavity share of the total volume is about 39%. Accordingly, the volume increase of the wobbler 28 is about 39% when it is brought from the first to the second extreme position, and the share of the cavities 53 and 54 of the total volume of the wobbler 28 is changed with 24 percentage units between the two extreme positions.

As is evident from FIG. 8 and 9, also the length of the 5 wobbler body is freely adjustable between a first predetermined length l₁, which the wobbler 28 has in the first extreme position (see FIG. 8), and a second predetermined length l₂, which the wobbler has in the second extreme position (see FIG. 9). When the wobbler 28 being set into the first extreme position (FIG. 8) is brought to travel through the water, for example by retrieving it by means of a fishing reel or by means of so-called “trolling”, i.e. towing it behind a boat, the wobbler 28 will oscillate with a first frequency f₁, being a function of the speed of the wobbler 28 through the water v. When the wobbler 28 being set into the second extreme position (FIG. 9) is brought to travel through the water, the wobbler will oscillate with a frequency f₂ which, at the same speed v, is lower than f₁. Accordingly, a wobbler being set into a position between the two extreme positions will oscillate with a frequency which, at the same speed v, is lower than f₁ but higher than f₂. Accordingly, in addition to a freely adjustable setting of the buoyancy between two buoyancy values, for a predetermined speed v and within the frequency interval being defined by the extreme positions, i.e. f₁-f₂, said relative movement between the structural members 29, 39 also enables a freely adjustable setting of the frequency with which the wobbler 28 oscillates when it is brought to travel through the water.

As used herein, “freely adjustable setting” means that a continuous or stepwise adjustment of the displacement value and the length value, respectively, is possible between the respective extreme values.

Trials have shown that the change of length between the two extreme positions should be at least 5% in order to obtain a change of frequency which is effective in practical fishing. Preferably, however, the change of length should be at least 10% and advantageously even more. In the embodiment shown in FIG. 7-9, l₁ is about 10 centimetres and l₂ is about 13 centimetres and, consequently, the change of length between the two extreme positions is about 30%.

In order to prevent a wobbler according to the invention from “skewing” when it is brought to travel through the water, the wobbler preferably should exhibit an external shape which is substantially symmetrical around the centre plane of the wobbler. As used herein, “centre plane” means the plane shown by the sectional figures, i.e. the standing or vertical plane extending along the longitudinal axis of the wobbler. Accordingly, such a centre plane defines a longitudinal, standing symmetry plane which, in a longitudinal direction, divides the wobbler into two substantially similar portions. As is evident from FIG. 10 and 11, the front-end structural member 29 of the wobbler 28 exhibits such a symmetry plane, i.e. the shown sectional plane, whereas the rear-end structural member 30 of the wobbler 28 is substantially rotationally symmetrical around its longitudinal axis. Accordingly, independently of the position of the rear-end structural member 30 in relation to the front-end structural member 29, the wobbler as a whole always exhibits a symmetry plane in accordance with the foregoing. In other words, the wobbler 28 exhibits a symmetry plane in all its possible settings.

When at rest, i.e. when it is not travelling through the water, the orientation of the wobbler on or in the water is determined by the position of the mass centre of the wobbler in relation to the mass centre of the displacement, i.e. the mass centre of the displaced water. Since gravity attacks in the mass centre of the wobbler and the net lift in the mass centre of the displacement, a wobbler at rest will assume an equilibrium position, where the mass centre of the displacement is located vertically above the mass centre of the wobbler.

Preferably, the wobbler according to the invention, when at rest, should be arranged in order to assume an equilibrium position where the wobbler is turned the right side up, i.e. having the backside upwards. Furthermore, the wobbler, when at rest, should be arranged in order to assume an equilibrium position where the wobbler is substantially horizontal. However, instead of an entirely horizontal orientation, the wobbler can be arranged in order to assume a slightly forward-tilted orientation, i.e. an orientation where the front end of the wobbler is located lower in the water than its rear end, something which ensures that the oscillating motion of the wobbler is initiated quickly when it once again is brought to travel through the water.

Preferably, the wobbler according to the invention, when at rest, is arranged in order to assume equilibrium positions in accordance with the foregoing, in all its possible settings, i.e. in the two extreme positions and all intermediate positions. This is achieved by means of an embodiment of the wobbler where the structural members 2, 3 and 29, 30, respectively, are designed so that, for all possible settings:
i) the mass centre of the displacement and the mass centre of the wobbler are located in the centre plane of the wobbler when the wobbler is immersed completely in water;
ii) the mass centre of the displacement is closer to the backside of the wobbler than the mass centre of the wobbler when the wobbler is immersed completely in water;
iii) the mass centre of the wobbler is located at the same distance from the front end of the wobbler as the mass centre of the displacement, or closer to the front end of the wobbler than the mass centre of the displacement, when the wobbler is immersed completely in water.

By means of i), it is ensured that the wobbler, in its equilibrium position, always orientates itself so that its centre plane-coincides with the vertical line, i.e. so that the wobbler does not exhibit a list in any direction. By means of ii), it is ensured that the wobbler, in its equilibrium position, always orientates itself with its backside upwards. By means of iii), it is ensured that the wobbler, in its equilibrium position, always assumes a horizontal or forward-tilted orientation.

The motion of the wobbler when it is brought to travel through the water, however, also is dependent on where said mass centres are located in relation to each other. Trials have shown, for example, that the best motion is obtained when the mass centre of the wobbler is located closer to the front end of the wobbler than the mass centre of the displacement, but that the irrational motion exhibited by a wobbler when the mass centre of the displacement is closer to the front end of the wobbler than the mass centre of the wobbler, in certain fishing situations, can be extremely attractive to fishes of prey. In certain fishing situations, the advantages with this irrational motion can outweigh the disadvantage that a wobbler being designed in this way assumes an equilibrium position where the front end of the wobbler is located higher in the water than its rear end. According to one embodiment of the invention, accordingly, the structural members 2, 3 and 29, 30, respectively, are designed so that the mass centre of the displacement is located closer to the front end of the wobbler than the mass centre of the wobbler in at least in one of the possible settings of the wobbler.

In the foregoing, the invention has been described in connection with a few specific embodiments of a wobbler. It will be understood, however, that the principle of the invention is equally applicable on other types of wobblers and lures. It will also be understood that the lure according to the invention can be made of number of different materials or material combinations, for example different types of plastics, metal or wood, wherein different positive and/or negative buoyancy intervals can be obtained. For instance, in a wobbler exhibiting front-end and rear-end structural members in accordance with the foregoing, the structural members can be made of different materials. It will also be understood that the above-mentioned cavities can be realized in other ways than the ones described above, for example the lure can comprise one, three or several cavities having variable volumes, which are enclosed by more than two structural members being movable in relation to each other. It will also be understood that said cavity can be filled with an other gas than air. Alternatively, said cavity can be completely or partially fillable with a liquid, in which case the lure preferably also comprises a valve, through which the liquid can be drawn off or supplied to said cavity when performing said change of displacement.

Furthermore, it will be understood that the structure of the lure, where said structural members 2 and 3 and 29 and 30, respectively, form the front and rear body of the lure, respectively, enables the fisherman to compose the colour combination of the lure which he desires himself, since front and rear bodies of different colours can be freely combined with each other.

1. A lure having at least one point of attachment for a line and at least one point of attachment for a hook, the lure comprising at least one first structural member and at least one second structural member said structural members enclosing at least one cavity having a volume which is variable by means of a relative movement between the structural members said relative movement bringing about a change of displacement of the lure.

2. A lure according to claim 1, wherein the cavity is filled with gas, and wherein the lure comprises sealing members in order to prevent water from penetrating into said cavity.

3. A lure according to claim 1, wherein said relative movement comprises a rotary motion of the first structural member in relation to the second structural member.

4. A lure according to claim 3, wherein the first structural member is in a threaded engagement with the second structural member.

5. A lure according to claim 1, comprising two of said cavities.

6. A lure according to claim 1, wherein one of the structural members is substantially rotationally symmetrical.

7. A lure according to claim 1, wherein said relative movement results in a volume increase of the lure which is at least 10%, preferably at least 20%.

8. A lure according to claim 1, wherein the length of the lure is freely adjustable, by means of relative movement of the structural members, between a predetermined first length which the lure has in a first extreme position, and a predetermined second length which the lure has in a second extreme position, said second length being longer than the first length.

9. A lure according to claim 8, wherein the second length is at least 5%, preferably at least 10%, longer than the first length.

10. A lure according to claim 1, wherein said displacement-changing relative movement is the same movement as said length-changing relative movement.

11. A lure according to claim 1, wherein the lure, in all its possible settings, exhibits a longitudinal, standing centre plane which, in a longitudinal direction, divides the lure into two substantially similar portions.

12. A lure according to claim 1, wherein the lure, when at rest, is arranged in order to assume an equilibrium position where the lure is turned the right side up and is substantially horizontal or slightly forward-tilted.

13. A lure according to claim 12, wherein the structural members of the lure are designed so that, for all possible settings, the mass centre of the displacement and the mass centre of the wobbler are located in the centre plane of the lure when the lure is immersed completely in water.

14. A lure according to claim 12, wherein the structural members of the lure are designed so that, for all possible settings, the mass centre of the displacement is closer to the backside of the lure than the mass centre of the lure when the lure is immersed completely in water.

15. A lure according to claim 12, wherein the structural members of the lure are designed so that, for all possible settings, the mass centre of the lure is located at the same distance from the front end of the lure as the mass centre of the displacement, or closer to the front end of the lure than the mass centre of the displacement, when the lure is immersed completely in water.

16. A lure according to claim 1, wherein the lure is a wobbler.
